(19) United States
(12) Patent Application Publication
(10) Pub. No.: US 2007/0177693 A1
(43) Pub. Date: Aug. 2, 2007

(54) Integrated circuit arrangement for converting a high-frequency bandpass signal to a low-frequency quadrature signal

(75) Inventor: Wolfram Kluge, Dresden (DE)

Correspondence Address: MCGRATH, GEISSLER, OLDS & RICHARDSON, PLLC, P.O. BOX 1364, FAIRFAX, VA, 22038-1364, US

(73) Assignee: ATMELGermany GmbH

(21) Appl. No.: 11/700,787

(22) Filed: Feb. 1, 2007

(30) Foreign Application Priority Data
Feb. 1, 2006 (DE) DE 102006004951.9

(51) Int. Cl. H04L 27/22

(52) U.S. Cl. 375/332

(57) ABSTRACT

An integrated circuit arrangement is provided for converting a high-frequency bandpass signal to a low-frequency quadrature signal with a first in-phase component and a first quadrature-phase component, which has: an amplifier arrangement, which is designed to generate an amplified signal and has a first amplifier stage for amplifying the high-frequency bandpass signal, a mixer unit with a first mixer to provide the first in-phase component and a second mixer to provide the first quadrature-phase component, and a driver amplifier, which is designed to generate a local oscillator signal. According to the invention, between the amplifier arrangement and the mixer unit a polyphase filter is disposed, which converts the amplified signal to a complex-valued polyphase signal with a second in-phase component and a second quadrature phase component. Furthermore, according to the invention each mixer is connected to the driver amplifier, and the first mixer is designed to multiply the second in-phase component by the local oscillator signal, and the second mixer is designed to multiply the second quadrature-phase component by the local oscillator signal.

This nonprovisional application claims priority under 35 U.S.C. § 119(a) on German Patent Application No. 102006004951, which was filed in Germany on Feb. 1, 2006, and which is herein incorporated by reference.

### BACKGROUND OF THE INVENTION

1. Field of the Invention

The present invention relates to an integrated circuit arrangement for converting a high-frequency bandpass signal to a low-frequency quadrature signal. The invention relates furthermore to a transmitting/receiving device with a circuit arrangement of this type.

2. Description of the Background Art

The invention is in the field of communication systems, in which a plurality of transmitting/receiving devices access a specific frequency band or carrier frequency channels contained therein. It is particularly in the field of integrated circuits, with whose help in such transmitting/receiving devices on the receiver side a high-frequency bandpass signal, such as, e.g., a radio signal received via an antenna, is converted (transformed) to a low-frequency quadrature signal of fixed frequency, before the data values contained therein and originating from another transmitting/receiving device are detected.

Although it can be used in principle in any wireless or hard-wired digital telecommunication systems, the present invention and the problem on which it is based will be explained below with reference to a “ZigBee” communication system in accordance with IEEE 802.15.4.

So-called “Wireless Personal Area Networks” (WPANs) can be used for the wireless transmission of information over relatively short distances (about 10 m). In contrast to “Wireless Local Area Networks” (WLANs), WPANs require little or even no infrastructure for data transmission, so that small, simple, energy-efficient, and cost-effective devices can be implemented for a broad range of applications.

The standard IEEE 802.15.4 specifies low-rate WPANs, which with raw data rates up to a maximum of 250 kbit/s and stationary or mobile devices are suitable for applications in industrial monitoring and control, in sensor networks, in automation, and in the field of computer peripherals and for interactive games. An extremely low power requirement of the device is of critical importance for such applications, in addition to a very simple and cost-effective implementability of the devices. Thus, an objective of this standard is a battery life of several months to several years.

At the level of the physical layer, IEEE 802.15.4 specifies a total of 16 (carrier frequency) channels with a channel raster of 5 MHz in the ISM band (industrial, scientific, medical), available virtually worldwide, of 2.400 to 2.483 GHz. In these channels, a symbol rate of 62.5 ksymbols/s and band spreading (spreading) with a chip rate of fC=2 Mchip/s, as well as an offset QPSK modulation (quaternary phase shift keying), are provided for raw data rates of 250 kbit/s).

The bandpass radio signal transmitted in one of the channels of the ISM band is to be converted to a low-frequency quadrature signal of fixed frequency on the receiver side in an integrated circuit arrangement, which is also called an “HF front end.” The low-frequency quadrature signal in this case can be within an intermediate frequency range (intermediate frequency, IF) or in the baseband range (“zero IF”). In particular, this can be a low intermediate frequency (“low IF”), in comparison with the operating/carrier frequency. The quadrature signal is complex-valued and has an in-phase component and a quadrature-phase component.

Whereas other units of the receiver must be activated only after successful synchronization, the HF front end must be active on the preamble sequence even during the so-called listen phase (“RX Listen Mode”). Furthermore, the current consumption in assemblies, which are operated at frequencies in the gigahertz range, is much higher than in the assemblies which are operated at lower frequencies. For these reasons, the energy consumption of the HF front-end circuit arrangement is very important for the energy consumption of the entire transmitting/receiving device.

Known integrated HF front-end circuit arrangements have a low-noise amplifier (LNA) and a quadrature mixer for spectral down conversion of the amplified signal. To provide the in-phase component (I) and the quadrature-phase component (Q) of the low-frequency quadrature signal, the quadrature mixer, which is also called the image-reject mixer, has two active mixers. The two mixers are driven by two local oscillator signals, which are phase shifted by 90 degrees relative to one another and provided by two driver amplifiers. This type of circuit arrangement is known, for example, from the article “Low-Voltage Low-Power CMOS-RF Transceiver Design” by M. S. J. Steyaert et al. (pp. 281-287) in IEEE Transactions on Microwave Theory and Techniques, Vol. 50, No. 1 (January 2002).

A disadvantage here is the high power consumption during operation and the increased implementation cost. The active mixers and the two driver amplifiers in particular contribute to this.

### SUMMARY OF THE INVENTION

It is therefore an object of the present invention to provide an integrated HF front-end circuit arrangement, which is energy-efficient to operate and simple to implement, so that energy-efficient and powerful transmitting/receiving devices, which are cost-effective to realize, are made possible.

The integrated circuit arrangement according to an embodiment of the invention for converting a high-frequency bandpass signal to a low-frequency quadrature signal with a first in-phase component and a first quadrature-phase component includes the following units: a) an amplifier arrangement, which is designed to generate an amplified signal and has a first amplifier stage for amplifying the high-frequency bandpass signal, b) a mixer unit with a first mixer to provide the first in-phase component and a second mixer to provide the first quadrature-phase component, c) a driver amplifier (buffer), which is designed to provide a local oscillator signal, and d) a polyphase filter, which is disposed between the amplifier arrangement and the mixer unit and is designed to convert the amplified signal to a complex-valued polyphase signal with a second in-phase component and a second quadrature-phase component, whereby e) each mixer is connected to the driver amplifier and the first mixer is designed to multiply the second in-phase component by the local oscillator signal, and the second mixer is designed to multiply the second quadrature-phase component by the local oscillator signal.

The transmitting/receiving device according to an embodiment of the invention has a circuit arrangement of this type.

An object of the invention is to perform the I/Q signal generation in the signal path of the incoming signal with the use of the polyphase filter and to multiply the I or Q component of the polyphase signal with the same local oscillator signal in the mixer unit. Because only a (non-quadrature) local oscillator signal is necessary, the I/Q signal generation in the local oscillator path is eliminated. As a result, the second driver amplifier, otherwise necessary to provide the Q component of the local oscillator signal, and the associated power consumption and realization cost can be advantageously eliminated. In addition, the polyphase filter advantageously decouples the two mixers from one another and reduces feedback, so that the noise at the output of the HF front-end circuit arrangement is reduced. This type of integrated HF front-end circuit arrangement is energy-efficient to operate and simple to implement, so that transmitting/receiving devices are made possible that are powerful yet simple and cost-effective to implement and energy-efficient to operate.

In a first embodiment, the mixer unit can be configured as passive and each mixer has at least one MOSFET transistor with a gate terminal, which is connected to the driver amplifier, so that it is possible to control the MOSFET transistor by means of the local oscillator signal. This type of circuit arrangements has especially low power consumption and is very simple to implement. Advantageously no direct current flows through the mixer unit in this case, so that no shot noise (1/f noise) occurs. In addition, MOSFET transistors advantageously have a high large-signal stability, because their IP3 point (third-order intercept point) is relatively high.

In another embodiment, each MOSFET transistor can have a second terminal, connected to the polyphase filter, and a third terminal, connected to an operational amplifier. The operational amplifiers in this case are preferably a component of a filter connected on the output side to the mixer unit, particularly a filter for channel selection. This further simplifies the realization of the integrated circuit arrangement.

In another embodiment, precisely one driver amplifier is provided to convert the high-frequency bandpass signal to the low-frequency quadrature signal. This type of circuit arrangement is very simple to implement and has an especially low power consumption.

In further embodiment, the polyphase filter has exclusively passive, preferably only resistive and capacitive elements. As a result, it is possible to achieve an especially low power consumption and an especially simple implementability of the circuit arrangement and thereby of the transmitting/receiving device.

The polyphase filter can be designed as a second-order polyphase filter. As a result, it is possible to broaden advantageously the frequency range in which the polyphase filter acts as a band-stop filter.

Advantageously, the polyphase filter can have at least two all-pass filters with a different cut-off frequency. A phase shift of 90 degrees can be achieved by this means within a broad frequency range.

In a third embodiment, the amplifier arrangement has a second amplifier stage, connected after the first amplifier stage, for generating the amplified signal and is configured to supply the two amplifier stages with operating power according to the principle of current reuse. High amplifications without an increased power demand can be achieved advantageously by this means. Furthermore, this makes it possible to reduce the noise figure of the HF front-end circuit arrangement.

Coupling capacitors can be provided between the amplifier arrangement and the polyphase filter and/or between the polyphase filter and the mixer unit to suppress direct currents. Advantageously no shot noise (1/f noise) occurs as a result.

The mixer unit can have precisely two mixers for providing the first in-phase component and the first quadrature-phase component. As a result, it is possible to achieve an especially simple implementability of the circuit arrangement and thereby of the transmitting/receiving device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a “Wireless Personal Area Network” (WPAN) according to the IEEE Standard 802.15.4 with transmitting/receiving devices of the invention;

FIG. 2 shows an exemplary embodiment of a receiving unit of a transmitting/receiving device according to IEEE 802.15.4 with the circuit arrangement of the invention;

FIG. 3 shows an embodiment of the polyphase filter of a circuit arrangement of the invention;

FIG. 4 shows an embodiment of the mixer unit of a circuit arrangement of the invention; and

FIG. 5 shows an embodiment of the amplifier arrangement of a circuit arrangement of the invention.

### DETAILED DESCRIPTION

In the figures, the same and functionally identical elements and signals, if not specified otherwise, are provided with the same reference characters.

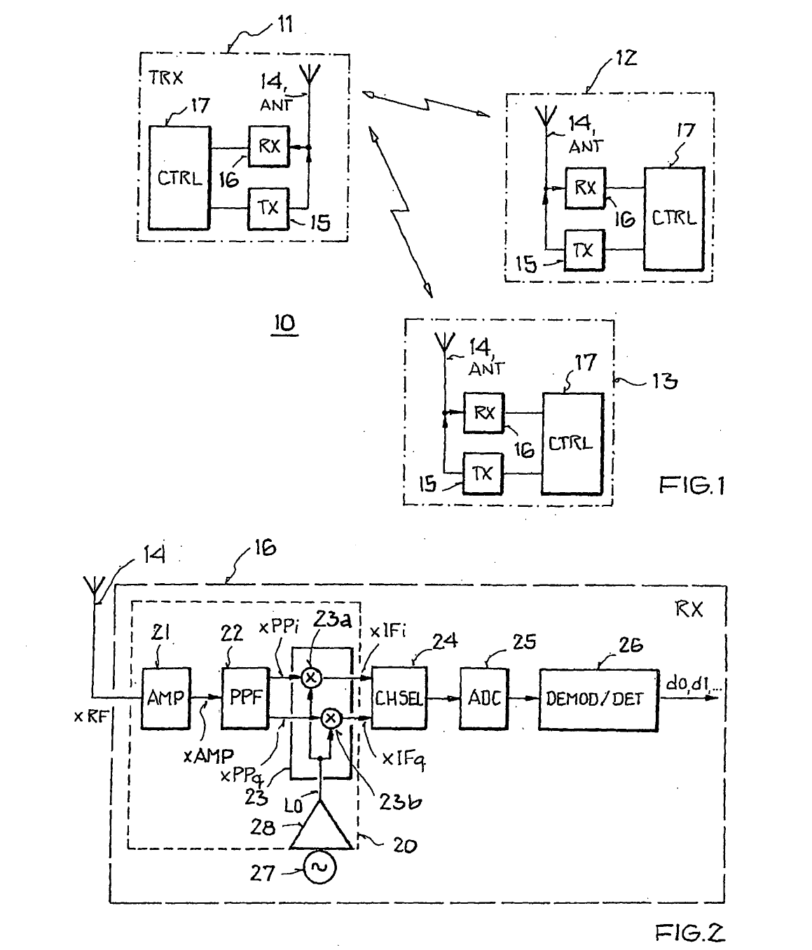

FIG. 1 shows an example of a “Wireless Personal Area Network” (WPAN) 10 according to IEEE standard 802.15.4. It comprises three transmitting/receiving devices (transceiver, TRX) 11-13 in the form of stationary or mobile devices, which exchange information in a wireless manner by means of radio signals. Transmitting/receiving device 11 is a so-called full-function device, which takes on the function of the WPAN coordinator, whereas transmitting/receiving devices 12, 13 are so-called reduced-function devices, which are assigned to full-function device 11 and can only exchange data with said device. Apart from the star network topology depicted in FIG. 1, in which bidirectional data transmission can only occur between one of the reduced-function devices 12, 13 and the full-function device 11, but not between reduced function devices 12, 13, the standard also provides so-called “peer-to-peer” topologies, in which all full-function devices can communicate with all other full-function devices.

Transmitting/receiving devices 11-13 each comprise an antenna 14, a transmitting unit (transmitter, TX) 15 connected to the antenna, a receiving unit (receiver, RX) 16 connected to the antenna, and a control unit (control unit, CTRL) 17, connected to the transmitting and receiving unit, to control transmitting and receiving units 15, 16. Furthermore, transmitting/receiving units 11-13 each contain a power supply unit, not shown in FIG. 1, in the form of a battery, etc., to supply power to units 15-17, and possibly other components such as sensors, etc.

It will be assumed in the following text that the data transmission occurs in the 2.4-GHz ISM band (industrial, scientific, medical).

Transmitting unit 15 of each transmitting/receiving device converts the data stream to be transmitted according to IEEE Standard 802.15.4 into a radio signal to be emitted over its antenna 14 by first converting the data stream to be transmitted (raw data rate: 250 kbit/s) to four bit symbols (symbol rate: 62.5 ksymbol/s) and these into successive symbol value-specific PN sequences (pseudo-noise) of 32 chips in each case (chip rate: fC=2 Mchip/s). The successive PN sequences are then offset-QPSK-modulated (quaternary phase shift keying), spectrally shifted into one of 16 channels in the ISM band, and finally amplified for the transmission.

Receiving unit 16 of each transmitting/receiving device converts a radio signal received from its antenna 14 and generated by the transmitting unit of another transmitting/receiving device according to IEEE Standard 802.15.4 without errors if possible into the transmitted data by amplifying the received radio signal, inter alia, transforming it into the baseband, filtering and demodulating it, and detecting (deciding) the data.

Transmitting unit 15 and receiving unit 16 of a transmitting/receiving device are hereby part of an integrated circuit (not shown in FIG. 1), e.g., an ASIC (application specific integrated circuit) or ASSP (application specific standard product) realized using CMOS technology, whereas control unit 17 is realized by means of a microcontroller (also not shown). Advantageously, the transmitting/receiving device has only one integrated circuit (e.g., made as ASIC or ASSP), which senses the functions of transmitting unit 15, receiving unit 16, and control unit 17.

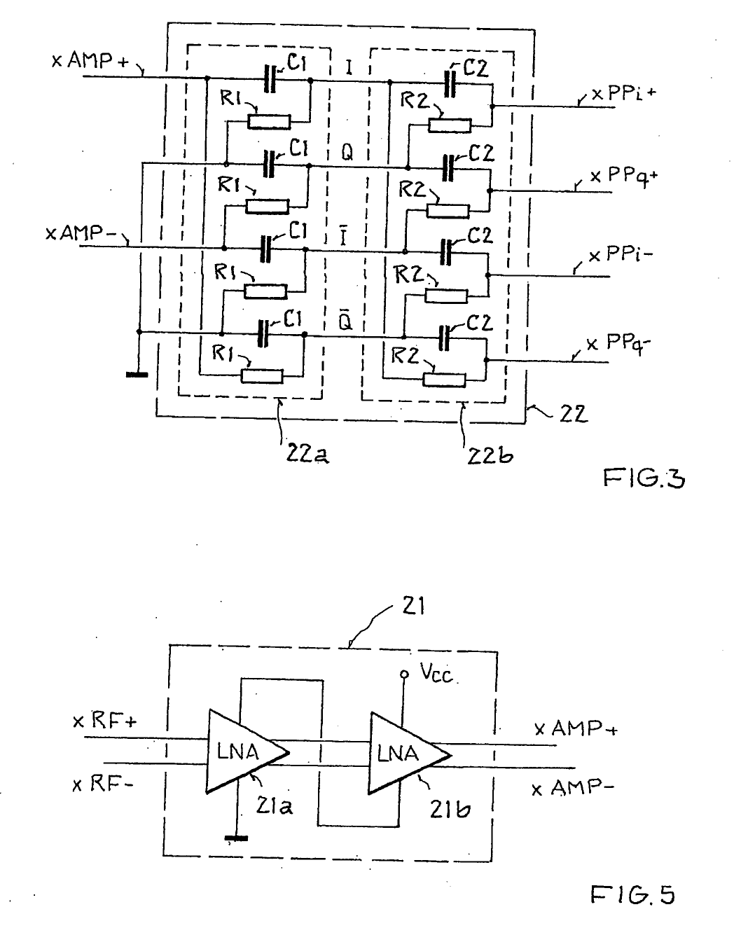

FIG. 2 shows a block diagram of an exemplary receiving unit (RX) 16 with an integrated circuit arrangement 20 of the invention.

Receiving unit 16 has the following units connected in series: Circuit arrangement 20, connected to antenna 14 and to an oscillator 27, an analog filter unit (CHSEL) 24, an analog-to-digital converter (ADC) 25, and a digital demodulation/detection unit (DEMOD/DET) 26.

HF front-end circuit arrangement 20 amplifies the high-frequency bandpass signal (radio signal) xRF received by antenna 14, which lies spectrally in the ISM band, and converts (transforms) it to a relatively low-frequency quadrature signal xIF in an intermediate frequency range, for example, at fIF=2 MHz (intermediate frequency, IF). Because of the value of the intermediate frequency fIF, which is low in comparison with the operating or carrier frequency at about 2.4 GHz, receiving unit 16, shown in FIG. 2, is called a “low IF” receiving unit. The low-frequency quadrature signal xIF is a complex-valued bandpass signal, which has an in-phase component xIFi and a quadrature-phase component xIFq, which are provided at an in-phase output or at a quadrature-phase output of circuit arrangement 20. Circuit arrangement 20 of the invention can also be used in so-called “zero-IF” receiving units, in which the low-frequency quadrature signal is a complex-valued low-pass signal in the baseband range.

The analog filter unit (CHSEL) 24 is designed to derive a bandpass signal by filtering the low-frequency quadrature signal xIF in such a way that signal portions outside the useful band, i.e., the basic channel frequency band, are suppressed. Filter unit 24 serves, on the one hand, to select the desired channel (basic channel) or to suppress the adjacent channels and, on the other, for noise band limiting. For this purpose, the bandwidth of the quadrature signal xIF is limited in filter unit 24 with the use of complex filtering.

Analog filter unit 24 comprises, for example, three active single sideband RC resonators, which produce a 2 MHz-wide bandpass filter with a Butterworth characteristic at a center frequency of 2 MHz.

The output signal of analog filter unit 24 is sampled by analog-to-digital converter (ADC) 25, e.g., at a sampling rate of 16 Msps (megasamples per second) and quantized with a bit width of only one bit.

After a spectral shift into the baseband, not shown in FIG. 2, the resulting signal is demodulated and equalized in digital demodulation/detection unit (DEMOD/DET) 26 and then the originally transmitted data symbols d0, d1, . . . are detected (decided).

The previously described embodiment and sequence of the units 24-26 are to be taken to be exemplary.

Oscillator 27 is preferably a voltage-controlled oscillator (VCO), whose frequency, for example, is set with use of a phase-locked loop (PLL).

Integrated circuit arrangement 20 has an amplifier arrangement (AMP) 21, a polyphase filter (PPF) 22, a mixer unit 23, and precisely one driver amplifier 28.

Amplifier arrangement 21 is connected on the input side to antenna 14 and on the output side to polyphase filter 22. Polyphase filter 22 is connected on the input side to amplifier arrangement 21 and on the output side via an in-phase (I) output and a quadrature-phase (Q) output to mixer unit 23. Mixer unit 23 is connected on the input side to the I output and the Q output of polyphase filter 22 and to driver amplifier 28. On the output side, mixer unit 23 is connected to analog filter unit 24 via an in-phase output and a quadrature-phase output. Driver amplifier 28 is connected on the input side to oscillator 27 and on the output side to mixer unit 23.

Amplifier arrangement (AMP) 21 generates an amplified signal xAMP and, for this purpose, has at least one low-noise amplifier stage or an at least one-stage low-noise amplifier (LNA) for amplifying the radio signal xRF. The useful signal is amplified by this to such an extent that following units have only a minor effect on the signal-to-noise ratio. A preferred embodiment of amplifier arrangement 21 is described hereafter with reference to FIG. 5;

Polyphase filter (PPF) 22 converts the real-valued amplified signal xAMP to a complex-valued polyphase (quadrature) signal xPP with an in-phase component xPPi and a quadrature-phase component xPPq and provides the in-phase component xPPi at its in-phase output and the quadrature-phase component xPPq at its quadrature-phase output. The I/Q signal generation therefore occurs in the signal path of the incoming signal.

The polyphase signal xPP represents the analytical signal xAMP+j*H{xAMP}, assigned to the amplified signal xAMP, where H{xAMP} stands for the Hilbert transform of the amplified signal xAMP. Polyphase filter 22 suppresses as much as possible spectral portions of xAMP at negative frequencies, whereas at positive frequencies spectral portions pass through polyphase filter 22 as unchanged as possible.

Polyphase filter 22 preferably has exclusively passive elements and therefore does not stress the power supply unit (battery) of the particular transmitting/receiving device 11-13 (FIG. 1). A preferred embodiment of polyphase filter 22 is described hereafter with reference to FIG. 3.

Driver amplifier 28 amplifies the output signal of oscillator 27 and provides a local oscillator signal LO at its output. The driver amplifier is made as a buffer, for example.

Precisely one local oscillator signal is provided to convert the high-frequency bandpass signal xRF to the low-frequency quadrature signal xIF. Apart from this local oscillator signal LO, no other local oscillator signal is provided, particularly no oscillator signal phase-shifted to oscillator signal LO.

Mixer unit 23 shifts the high-frequency polyphase signal xPP with the use of the local oscillator signal LO spectrally into the intermediate frequency range by fIF and provides the in-phase component xIFi of the resulting low-frequency quadrature signal xIF at its in-phase output and the quadrature-phase component xIFq of xIF at its quadrature-phase output.

Mixer unit 23 has a first mixer 23a and a second mixer 23b. On the input side, first mixer 23a is connected via the in-phase input of mixer unit 23 to the in-phase output of polyphase filter 22, whereas second mixer 23b is connected on the input side via the quadrature-phase input of mixer unit 23 to the quadrature-phase output of polyphase filter 22. Both mixers 23a, 23b are connected in addition on the input side to the output of driver amplifier 28. On the output side, first mixer 23a is connected via the in-phase output of mixer unit 23 to the in-phase input of filter unit 24, whereas second mixer 23b is connected on the output side via the quadrature-phase output of mixer unit 23 to the quadrature-phase input of filter unit 24.

First mixer 23a mixes (multiplies) the in-phase component xPPi of the polyphase signal xPP with the local oscillator signal LO and provides the thus formed in-phase component xIFi of the quadrature signal xIF at the in-phase output of mixer unit 23. Similarly, second mixer 23b mixes (multiplies) the quadrature-phase component xPPq of the polyphase signal xPP with the (same) local oscillator signal LO and provides the thus formed quadrature-phase component xIFq of the quadrature signal xIF at the quadrature-phase output of mixer unit 23.

To provide the in-phase component xIFi and the quadrature-phase component xIFq, mixer unit 23 has a total of only two mixers 23a, 23b, i.e., precisely two (real-valued) mixers.

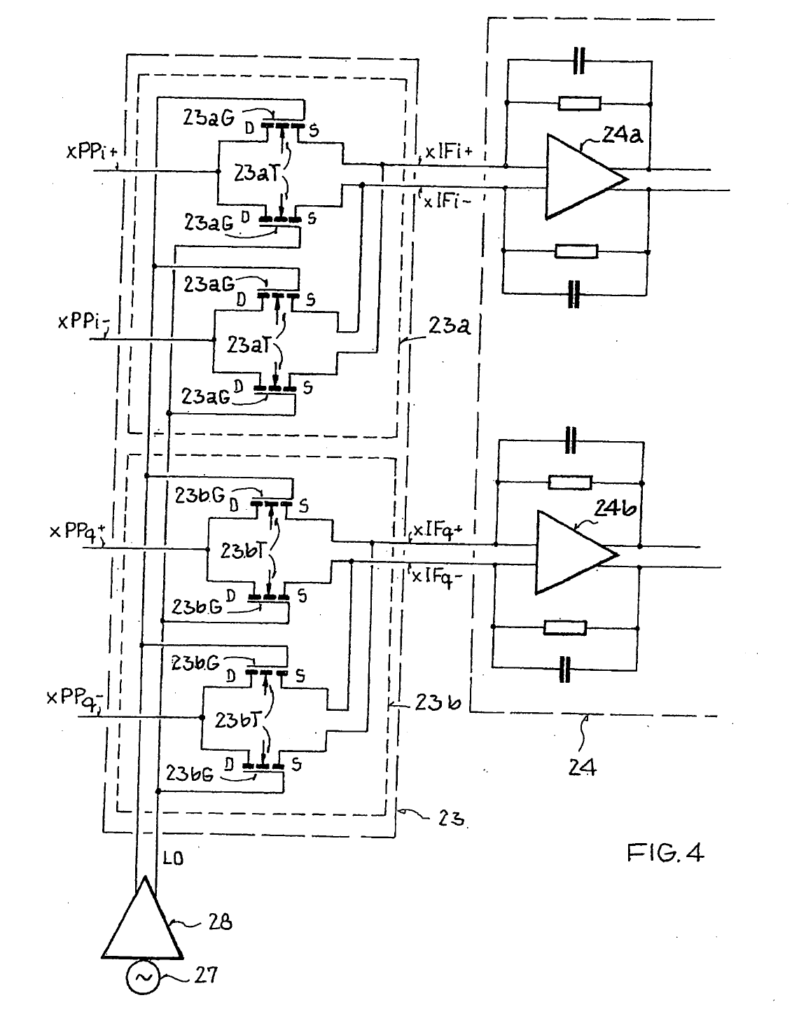

The two mixers 23a, 23b—and thereby mixer unit 23—are preferably configured as passive and therefore do not stress the power supply unit (battery) of the particular transmitting/receiving device 11-13 (see FIG. 1). An embodiment of mixer unit 23 is described hereafter with reference to FIG. 4.

According to the preceding description, the I/Q signal generation occurs in the signal path of the incoming signal xRF, so that no I/Q signal generation is necessary in the signal path of the local oscillator signal LO. The generation of the quadrature-phase component of the local oscillator signal and thereby also the otherwise necessary second driver amplifier for their provision are therefore advantageously eliminated. This makes possible powerful integrated front-end circuit arrangements 20, which are energy-efficient to operate and simple to implement.

Coupling capacitors are provided between amplifier arrangement 21 and polyphase filter 22 (not shown in FIG. 2), and it is thereby assured that no direct current flows across mixer unit 23. No shot noise (1/f noise) occurs advantageously as a result. Alternatively, the coupling capacitors may also be disposed between polyphase filter 22 and mixer unit 23, in this case twice as many coupling capacitors being necessary.

FIGS. 3 to 5, which are described next, show preferred embodiments of amplifier arrangement 21, polyphase filter 22, and mixer unit 23. In these embodiments, differential signals are used, which are characterized by double-circuit lines. Of course, instead of differential signals, non-differential signals can be processed generally or partially. Such “single-ended” realizations result from the elimination of the circuit parts that concern the corresponding inverted signals.

FIG. 3 shows a circuit diagram of an embodiment of polyphase filter 22 of FIG. 2.

A second-order polyphase filter with a first stage 22a and a second stage 22b is shown in this circuit diagram. Each stage comprises four capacitive elements C1 or C2 and four resistive elements R1 or R2, the elements of each stage being connected “ring-shaped” as shown.

Preferably, the capacitive elements C1, C2 are made as capacitors. Alternatively, they can be formed, for example, as varactors or as gate-bulk capacitors of a MOSFET transistor. The resistive elements R1, R2 are preferably formed as resistors. Alternatively, they can be made, e.g., as drain-source resistors of a MOSFET transistor.

The amplified signal xAMP, which is formed as a differential signal (see above), is applied at the differential in-phase input of the polyphase filter, which is designated by xAMP+ and xAMP− in FIG. 3. The differential quadrature-phase input is connected to ground. The in-phase component xPPi or the quadrature-phase component xPPq of the polyphase signal xPP are tapped differentially at the differential in-phase and quadrature-phase outputs, which are designated by xPPi+, xPPi−, or xPPq+, xPPq−, respectively.

The values of the elements R1, R2, C1, C2 are selected so that the two zero positions of the frequency response of the polyphase filter occur at frequency values in the vicinity of the negative operating frequency (−2.44 GHz). The further away the frequency values are from the zero position of the negative operating frequency, the broader the usable frequency range but also the higher the amplitude error of the polyphase signal xPP. The elements can be dimensioned as follows, for example: R1=833 ohm, R2=1195 ohm, C1=C2=66.24 fF.

The polyphase filter, shown in FIG. 3, has exclusively passive elements and therefore advantageously requires no separate power supply, so that integrated circuit arrangement 20 of FIG. 2 can be operated especially energy efficiently with this type of polyphase filter. Furthermore, the shown polyphase filter has exclusively resistive and capacitive elements (R1, R2, C1, C2), so that it can be implemented very simply.

In the positive frequency range at the operating frequency, the shown polyphase filter dampens the input signal xAMP advantageously relatively weakly. In addition, the polyphase filter decouples the two mixers 23a, 23b of the downstream-connected, preferably also passive mixer unit 23 (see FIGS. 2 and 4), so that feedback among the mixers is reduced and thereby the noise at the output of the circuit arrangement/mixer unit is advantageously reduced.

Instead of the second-order polyphase filter, shown in FIG. 3, it is also possible to provide polyphase filters of other orders, which have only one or at least three stages, however. The higher the selected order, the broader the frequency range that can be selected in which the polyphase filter acts as band-stop filter.

Other types of implementation can be selected instead of the polyphase filter structure, shown in FIG. 3. For example, the polyphase filter (“quadrature network”) may have two arms each with at least one first-order all-pass filter, whereby the all-pass filters of the two arms have different cut-off frequencies. A phase shift of 90 degrees between the in-phase output and the quadrature-phase output of the polyphase filter can be achieved advantageously in this manner within a broad frequency range. This type of implementation as well with all-pass filters can occur in a purely passive manner with the exclusive use of resistive and capacitive elements.

FIG. 4 shows a circuit diagram of a preferred embodiment of mixer unit 23 of FIG. 2. The two mixers are again designated with the reference characters 23a and 23b, whereas the reference character 24 designates the analog filter unit previously explained with reference to FIG. 2.

First mixer 23a has four MOSFET transistors 23aT each with a source, drain, and gate terminal. These four transistors 23aT can be divided into two pairs each with two of the transistors 23aT, the drain terminals (D) of the transistors of a pair being connected to one another.

The drain terminals (D) of the four transistors 23aT are connected via a differential input of first mixer 23a or the differential in-phase input of mixer unit 23, which is designated by xPPi+, xPPi− in FIG. 4, to the polyphase filter 22 in-phase output with the same name (see FIG. 3); here, the drain terminals of the first transistor pair, shown at the top of FIG. 4, are connected to the non-inverted output xPPi+, whereas the drain terminals of the second transistor pair, shown below in FIG. 4, of mixer 23a are connected to the inverted output xPPi−.

The source terminals (S) of transistors 23aT are connected to an operational amplifier 24a via a differential output of first mixer 23a or the differential in-phase output of mixer unit 23, which is designated by xIFi+, xIFi−in FIG. 4, and via the in-phase input of filter unit 24. In this case, the source terminals of the “top” transistor of the first pair and of the “bottom” transistor of the second pair are connected to one another and to the non-inverted output xIFi+, whereas the source terminals of the “bottom” transistor of the first pair and of the “top” transistor of the second pair are connected to one another and to the inverted output xIFi−.

Second mixer 23b also has four MOSFET transistors 23bT, which according to FIG. 4 are connected similar to transistors 23aT of first mixer 23a and on the drain side to the differential quadrature-phase input xPPq+, xPPq− and on the source side to the differential quadrature-phase output xIFq+, xIFq− of mixer unit 23.

The in-phase component xPPi of the polyphase signal xPP, which is formed as a differential signal, is applied at the differential in-phase input xPPi+, xPPi− of mixer unit 23, whereas the quadrature-phase component xPPq is applied at the differential quadrature-phase input xPPq+, xPPq−. The in-phase component xIFi or the quadrature-phase component xIFq of the quadrature signal xIF is tapped differentially at the differential in-phase and quadrature-phase outputs xIFi+, xIFi− or xIFq+, xIFq−, respectively, of the mixer unit.

Gate terminals 23aG, 23bG of transistors 23aT, 23bT of both mixers 23a, 23b are connected to driver amplifier 28, so that all transistors 23aT, 23bT are controlled by the local oscillator signal LO.

As is evident from FIG. 4, mixers 23a and 23b, which mix (multiply) the in-phase component xPPi or the quadrature-phase component xPPq of the polyphase signal xPP with the local oscillator signal LO, are realized passively. In this case, MOSFET transistors 23aT, 23bT are used as controllable resistors, and the resistors of the drain-source channels change in the local oscillator signal LO cycle. The two mixers 23a, 23b each work at a low-impedance load, which is preferably formed by an operational amplifier 24a, 24b, which is provided in any case as a component of the downstream-connected analog filter unit 24. No additional circuit components for this are therefore needed in the mixer unit.

Mixer unit 23, shown in FIG. 4, is configured as passive and therefore advantageously requires no separate power supply, so that the integrated circuit arrangement 20 of FIG. 2 can be operated especially energy efficiently with this type of mixer unit. No direct current advantageously flows through the mixer, so that no shot noise (1/f noise) occurs. In addition, this mixer unit has exclusively MOSFET transistors, which are notable for a high large-signal stability, because their IP3 point (third-order intercept point) is relatively high. Integrated circuit arrangement 20 can be implemented very simply with a mixer unit of this type.

The drain and source terminals of MOSFET transistors 23aT, 23bT alternatively can be exchanged in comparison with the circuit diagram shown in FIG. 4, so that the source terminals (S) are connected to the inputs of the mixer unit and the drain terminals (D) to the outputs.

The circuit diagram of mixer unit 23, as shown in FIG. 4, becomes simpler, when non-differential signals are used at the inputs and/or at the outputs of the mixer unit. If, for example, a non-differential polyphase signal is used on the input side, thus, the inverted inputs xPPi−, xPPq−of the mixer unit and the respectively “bottom” transistor pair of each mixer are eliminated in comparison with the circuit diagram according to FIG. 4. If a non-differential quadrature signal xIF is used on the output side, thus, additionally or solely the inverted outputs xIFi−, xIFq−of the mixer unit and thereby the “bottom” transistor of the “top” pair and the “top” transistor of the “bottom” pair of each mixer are eliminated. Mixer units whose mixers have a different number of transistors result in this way: If non-differential inputs and outputs are used, thus, each mixer has only one MOSFET transistor 23aT, 23bT. If, in contrast, non-differential inputs and differential outputs or conversely differential inputs and non-differential outputs are provided, thus, each mixer has two MOSFET transistors. The four MOSFET transistors per mixer, as shown in FIG. 4, result in the preferred case of differential inputs and outputs.

Instead of the N-channel MOSFET transistors shown in FIG. 4, P-channel MOSFET transistors may also be used. Instead of “enhancement mode” transistors, alternatively “depletion mode” transistors may be used. Finally, diodes may also be used instead of the MOSFET transistors.

If both mixer unit 23 and polyphase filter 22 are realized as passive according to the preceding description with reference to FIGS. 3 and 4, thus, solely amplifier arrangement 21 and driver amplifier 28 contribute to the power consumption of circuit arrangement 20 of FIG. 2. Especially energy-efficient HF front-end circuit arrangements, which are simple to implement, and thereby transmitting/receiving devices can be realized in this way.

FIG. 5 shows a block diagram of a preferred embodiment of amplifier arrangement 21 of FIG. 2.

Amplifier arrangement 21 has a first low-noise amplifier (LNA) 21a and preferably a downstream-connected second low-noise amplifier (LNA) 21b. First amplifier 21a forms the first stage of cascaded amplifier arrangement 21 and second amplifier 21b, the second stage. Both amplifier stages are preferably formed differentially.

First amplifier stage 21a is connected on the input side to the differential input xRF+, xRF− of amplifier arrangement 21, to which the radio signal xRF is supplied. Second amplifier stage 21b is connected on the output side to the differential output xAMP+, xAMP− of amplifier arrangement 21, to which the amplified signal xAMP is applied.

Second stage 21b increases the total amplification of the radio signal xRF. This is advantageous particularly when both mixer unit 23 and polyphase filter 22 are realized as passive (see, e.g., FIGS. 3 and 4) and a high total amplification factor is needed. In this case, the signal damping, caused by passive polyphase filter 22 and passive mixer unit 23, is compensated by the increased total amplification in amplifier arrangement 21, so that the HF front-end circuit arrangement 20 advantageously achieves a low noise figure.

As is evident from FIG. 5, both amplifier stages 21a, 21b are supplied with operating power according to the principle of current reuse. To accomplish this, the ground terminal of second amplifier stage 21b is connected to the operating voltage terminal of first stage 21a, whereas the supply voltage Vcc is applied at the operating voltage terminal of second stage 21b and the ground terminal of first stage 21a is connected to ground. Both amplifier stages are hereby supplied by the same operating current. There is no additional current requirement, therefore, due to second stage 21b. In this case, only a portion of the supply voltage Vcc is available to each amplifier stage 21a, 21b, and the reduced supply voltage is sufficient for operating each individual stage. Alternatively to the embodiment depicted in FIG. 5, the ground terminal of the first stage can also be connected to the operating voltage terminal of the second stage, in order to realize the principle of current reuse.

Both amplifier stages 21a, 21b are preferably implemented in a common-source configuration, and the output of the first stage is coupled capacitively to the input of the second stage. Alternatively, one of the amplifier stages or both stages can be realized in a common-gate or a cascode configuration.

The integrated HF front-end circuit arrangement, previously described with reference to FIGS. 2 to 5, is very simple to implement and especially energy-efficient to operate. It thereby makes possible energy-efficient and powerful transmitting/receiving devices which are cost-effective to realize.

Fully integrated, IEEE 802.15.4-conforming transceivers for the ISM band, realized by the applicant using a CMOS technology (0.18 μm), have a circuit arrangement of the invention, whose current consumption (including the LO driver amplifier) is about 3.5 mA. The HF front-end circuit arrangement occupies a chip area of about 300 μm×800 μm and meets all requirements for amplification, noise figure, large-signal stability (IP3, saturation), image frequency rejection, etc., to be achieved.

Although the present invention was described above with reference to exemplary embodiments, it is not limited thereto but can be modified in many ways. Thus, the invention is limited, for example, neither to WPANs per se, nor to WPANs according to IEEE 802.15.4, nor to the frequency bands, channel raster, transmitting powers, receiver sensitivity, etc., specified therein, nor to the provided values for intermediate frequency, filter orders, components, etc. The invention can be used advantageously in fact in highly diverse wireless or hard-wired digital communication systems.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An integrated circuit arrangement for converting a high-frequency bandpass signal to a low-frequency quadrature signal with a first in-phase component and a first quadrature-phase component, the integrated circuit arrangement comprising:
an amplifier arrangement for generating an amplified signal, the amplifier arrangement having a first amplifier stage for amplifying the high-frequency bandpass signal;
a mixer unit having a first mixer to provide the first in-phase component and having a second mixer to provide the first quadrature-phase component; and
a driver amplifier for providing a local oscillator signal;
wherein, between the amplifier arrangement and the mixer unit, a polyphase filter is provided that converts the amplified signal to a complex-valued polyphase signal with a second in-phase component and a second quadrature-phase component, and
wherein the first and second mixer are connected to the driver amplifier, the first mixer multiplying the second in-phase component by the local oscillator signal, and the second mixer multiplying the second quadrature-phase component by the local oscillator signal.

2. The integrated circuit arrangement according to claim 1, wherein the mixer unit is passive and the first and second mixer each have at least one MOSFET transistor with a gate terminal, which is connected to the driver amplifier to control the MOSFET transistor by the local oscillator signal.

3. The integrated circuit arrangement according to claim 2, wherein each MOSFET transistor has a second terminal connected to the polyphase filter, and a third terminal connected to an operational amplifier.

4. The integrated circuit arrangement according to claim 3, wherein the operational amplifiers are a component of a filter or a filter for channel selection and is connected on an output side to the mixer unit.

5. The integrated circuit arrangement according to claim 1, wherein precisely one driver amplifier converts the high-frequency bandpass signal to the low-frequency quadrature signal.

6. The integrated circuit arrangement according to claim 1, wherein the polyphase filter has passive elements.

7. The integrated circuit arrangement according to claim 6, wherein the polyphase filter has only resistive and capacitive elements.

8. The integrated circuit arrangement according to claim 1, wherein the polyphase filter is a second-order polyphase filter.

9. The integrated circuit arrangement according to claim 1, wherein the polyphase filter has at least two all-pass filters with a different cut-off frequency.

10. The integrated circuit arrangement according to claim 1, wherein the amplifier arrangement has a second amplifier stage connected after the first amplifier stage, for generating the amplified signal and is configured to supply the two amplifier stages with operating power based on current reuse.

11. The integrated circuit arrangement according to claim 1, wherein coupling capacitors are provided between the amplifier arrangement and the polyphase filter or/and between the polyphase filter and the mixer unit to suppress direct currents.

12. The integrated circuit arrangement according to claim 1, wherein the high-frequency bandpass signal has frequency portions in the gigahertz range.

13. The integrated circuit arrangement according to claim 1, wherein the low-frequency quadrature signal has frequency portions in the megahertz range.

14. The integrated circuit arrangement according to claim 1, wherein the mixer unit has precisely two mixers for providing the first in-phase component and the first quadrature-phase component.

15. The integrated circuit arrangement according to claim 1, wherein the first mixer provides the first in-phase component by multiplying the second in-phase component by the local oscillator signal, and the second mixer provides the first quadrature-phase component by multiplying the second quadrature-phase component by the local oscillator signal.

16. A transmitting/receiving device for a data transmission system comprising:
an antenna;
a receiving unit that is connected to the antenna; and
an integrated circuit arrangement the comprising:
an amplifier arrangement for generating an amplified signal, the amplifier arrangement having a first amplifier stage for amplifying the high-frequency bandpass signal;
a mixer unit having a first mixer to provide the first in-phase component and having a second mixer to provide the first quadrature-phase component; and
a driver amplifier for providing a local oscillator signal;
wherein, between the amplifier arrangement and the mixer unit, a polyphase filter is provided that converts the amplified signal to a complex-valued polyphase signal with a second in-phase component and a second quadrature-phase component, and
wherein the first and second mixer are connected to the driver amplifier, the first mixer multiplying the second in-phase component by the local oscillator signal, and the second mixer multiplying the second quadrature-phase component by the local oscillator signal.

17. The transmitting/receiving device according to claim 16, wherein the data transmission system transmits and/or receives according to according to IEEE standard 802.15.4.

18. A method for converting a high-frequency bandpass signal to a low-frequency quadrature signal with a first in-phase component and a first quadrature-phase component, the method comprising:
generating an amplified signal via an amplifier arrangement, the amplifier arrangement having a first amplifier stage for amplifying the high-frequency bandpass signal;
providing the first in-phase component via a mixer unit having a first mixer;
providing the first quadrature-phase component via a second mixer;
providing a local oscillator signal via a driver amplifier;
converting the amplified signal to a complex-valued polyphase signal with a second in-phase component and a second quadrature-phase component via a polyphase filter;
multiplying the second in-phase component by the local oscillator signal via the first mixer; and
multiplying the second quadrature-phase component by the local oscillator signal via the second mixer.

19. The method according to claim 18, wherein the first and second mixer are connected to the driver amplifier.

20. The method according to claim 18, wherein the polyphase filter is provided between the amplifier arrangement and the mixer unit.
